(19) United States
(12) Patent Application Publication
(10) Pub. No.: US 2012/0072293 A1
(43) Pub. Date: Mar. 22, 2012

(54) THE APPARATUS AND METHOD OF SELLING GOODS AND DIGITAL CONTENTS WITH BLOG SHARE SALES MODULE

(76) Inventor: Sung uk Cho, Gyeonggi-do (KR)

(21) Appl. No.: 13/263,827

(22) PCT Filed: Mar. 12, 2010
(86) PCT No.: PCT/KR2010/001549

§ 371 Date: Nov. 8, 2011

(30) Foreign Application Priority Data
Apr. 9, 2009 (KR) 10-2009-0030703

(51) Int. Cl. G06Q 30/02

(52) U.S. Cl. 705/14.73

(57) ABSTRACT

System and methods for selling goods and contents through a blog share sales module are disclosed. The system and methods improves the effect of advertising and goods sales. The blog share sales module is linked to the Internet shopping mall, open market system and contents sales system. Under the control of the blog share sales module, the goods/contents sales pages and auction page are inserted as an article in a blog, so that the goods sales and auction can be directly performed in the advertisement blog website. The bloggers who insert the pages as an article in blogs receive sales compensation.

### RELATED APPLICATIONS

This application is a U.S. National Stage application of and claims priority benefit of the Republic of Korea PCT Serial Number PCT/KR2010/001549 filed on Mar. 12, 2010, which in turn was based on Republic of Korea application Serial Number 10-2009-0030703(KR) filed on Apr. 9, 2009.

### BACKGROUND OF THE DISCLOSURE

a) Field of the Disclosure

This disclosure relates to a system and method for selling products and content through a blog share sales module, which allows product sales and auction pages of Internet shopping malls (i.e., online retailers), open markets, and content sales websites to be posted as blog articles in a marketing blog site, so that products and content can be directly sold or auctioned at the marketing blog site.

b) Background Art

The term “blog” generally refers to a form of personal media such as an Internet diary or a web log and also refers to a type of website in which users can post commentary, diary entries, news, daily life events, etc. The term netizens being a combination of the terms interNET and citiZEN as per the Random House dictionary (2011).

Blogs provide bidirectional communication, which allows active conversation between individuals in their personal spaces, and form tangible or intangible communities. Blogs described in the present disclosure include both general blogs and blog shops.

A variety of Internet shopping mall sales systems and methods utilizing such features of blogs have been proposed in the related art.

Google™ Inc. allows advertising words to be posted in blogs through their search advertising program, AdWords™, so that potential consumers can navigate to a relevant product sales website by clicking the posted advertising words.

Although this service has an advantage in that it can advertise products to potential consumers through associated words, it has a problem in that consumer click-through rates to the product sales website to view details of products are very low.

Korean Patent Application Publication No. 10-2006-0031471 incorporated herein by reference has suggested an electronic commerce method using blog shops which includes the steps of registering a blog shop, posting a product, registering a sponsor, ordering the product, posting the product status, and checking the product status.

In addition, Korean Patent Application Publication No. 10-2008-0030202 also incorporated herein by reference has suggested a method for advertising Internet shopping malls and selling products using blogs, which includes the steps of providing a personal page “Mypage” and a blog to a subscriber, receiving product information including shopping mall URL data and product image data, uploading the product information to one of a personally designated category, a recommended product category, a new product category, a popular product category, and a cooperative purchase/auction category and posting the uploaded product information in the blog, and providing the product information to blog visitors.

The Internet sales systems and methods of the above patent publications are characterized by adding shopping mall functionality to blogs.

Sellers compare the sales systems using blog shops with conventional shopping mall and open market sales systems and select a system which is more effective for selling their products.

However, in the current electronic commerce markets in which the methods of trading and auctioning products through Internet shopping malls and open markets have already been established as customary Internet sales methods, the blog shop sales methods have great difficulty in competing for sellers with the customary Internet sales methods although the blog shop sales methods surely have their own technical advantages. As a result, currently, there are almost no Internet shopping sites that employ the blog shop methods.

### SUMMARY OF THE DISCLOSURE

### Technical Problem

The apparatus and method disclosed herein solves the above problems, and it is an object of the present disclosure to provide a system and method for selling products and content through a blog share sales module, which allows a product sales/auction page of an Internet shopping mall, an open market, or a content sales website to be posted as an article in a blog so that a consumer can purchase or bid on a product directly in the product sales/auction page posted in the blog and which also allows bloggers who wish to receive an incentive for share sales to post product sales/auction pages in a marketing blog site, thereby promoting the sale or marketing of products to potential consumers.

### Technical Solution

In accordance with an embodiment of the disclosure, the above and other objects can be accomplished by the provision of a system for selling products and content through a blog share sales module, wherein the blog share sales module is provided in a server of an Internet shopping mall or open market, and wherein, under control of the blog share sales module, blogger identification information is added to a Uniform Resource Locator (URL) of a product sales/auction page, the URL with the blogger identification information added thereto is wrapped in iframe tags and the wrapped URL is posted as a blog article in a marketing blog site by operation in conjunction with an article editing function of the marketing blog site so that product sale/auction is performed directly through the product sales/auction page posted in the marketing blog site, and, when a sale or auction has been completed, sales incentive compensation is transferred to an email address of an individual who has posted the page as a blog article via an online payment system such as for example, the PayPal™ system.

In accordance with another embodiment of the present disclosure, the above and other objects can also be accomplished by the provision of a method for selling products through a blog share sales module, the method comprising a product registration process that includes registering product information and blog sales incentive information in an Internet shopping mall or open market including a blog share sales module, a blog posting process that includes checking, under control of the blog share sales module, product information and blog sales incentive information registered in the Internet shopping mall or open market and posting a sales/auction page of a product corresponding to the checked information as an article in a blog and then storing information regarding which page has been posted, who has posted the page, and where the page has been posted in a database, a blog dissemination process that includes copying a product sales/auction page posted in a blog as an article to a desired marketing blog site using a share button provided at one side of the product sales/auction page posted in the blog, and storing information regarding which page has been posted, who has posted the page, and where the page has been posted in the database, a product sales process that includes storing, through a program linked with an order button provided at one side of a product sales page posted as an article in the marketing blog site, order information of a product that is ordered through the button, a page URL, an order date, a price, and blog sales incentive information of the ordered product in the database, and delivering the ordered product to a destination by transmitting order data to the seller or by providing, when the product is content, the content product to the purchaser by allowing the purchaser to download a file containing the corresponding content or to view the corresponding content online, and a sales incentive process that includes determining, through a controller of the blog share sales module, whether or not payment and delivery for the product purchase and the blog sales have been completed, transmitting sales incentive billing information to the email address of the blog sharer who shares (specifically, aggregates or extracts) the blog article, and transferring blog sales incentive compensation to the blog sharer in one form via the online payment system.

### Advantageous Effects

The present disclosure has a variety of advantages. For example, the present disclosure can be applied not only to Internet shopping malls and sites for selling content such as music, movies, comics, images, software, and games but also to open markets. In addition, the present disclosure provides both functionality to sell products and functionality to perform auction through bidding. Thus, purchasers and sellers of products and bloggers who have shared the products form a community to promote the marketing of the products.

### BRIEF DESCRIPTION OF THE DRAWINGS

The above and other objects, features and other advantages of the disclosure will be more clearly understood from the following detailed description taken in conjunction with the accompanying drawings, in which:

FIG. 1 is a block diagram illustrating a system for selling products and content through a blog share sales module according to the disclosure;

FIG. 2 is a detailed block diagram illustrating the components of the system for selling products and content through a blog share sales module according to the disclosure;

FIG. 3 is a block diagram illustrating the components of the blog share sales module according to disclosure;

FIG. 4 is a block diagram illustrating a method for selling products through a blog share sales module in an Internet shopping mall regular-price sales system (SR type system) according to the disclosure;

FIG. 5 is a process diagram illustrating a method for selling products through a blog share sales module in an Internet shopping mall regular-price sales system (SR type system) according to the disclosure;

FIG. 6 is a block diagram illustrating a method for selling products through a blog share sales module in an Internet shopping mall auction sales system (SA type system) according to the disclosure;

FIG. 7 is a process diagram illustrating a method for selling products through a blog share sales module in an Internet shopping mall auction sales system (SA type system) according to the disclosure;

FIG. 8 is a block diagram illustrating a method for selling products through a blog share sales module in an open market regular-price sales system (OR type system) according to the disclosure;

FIG. 9 is a process diagram illustrating a method for selling products through a blog share sales module in an open market regular-price sales system (OR type system) according to the disclosure;

FIG. 10 is a block diagram illustrating a method for selling products through a blog share sales module in an open market auction sales system (OA type system) according to the disclosure;

FIG. 11 is a process diagram illustrating a method for selling products through a blog share sales module in an open market auction sales system (OA type system) according to the disclosure;

FIG. 12 is a block diagram illustrating a method for selling products through a blog share sales module in a shopping mall content online-delivery sales system (SC type system) according to the disclosure;

FIG. 13 is a process diagram illustrating a method for selling products through a blog share sales module in a shopping mall content online-delivery sales system (SC type system) according to the disclosure;

FIG. 14 is a block diagram illustrating a method for selling products through a blog share sales module in an open-market content online-delivery sales system (OC type system) according to the disclosure; and

FIG. 15 is a process diagram illustrating a method for selling products through a blog share sales module in an open-market content online-delivery sales system (OC type system) according to the disclosure.

### BRIEF DESCRIPTION OF SYMBOLS IN THE DRAWINGS

100: blog share sales module

110: share processing part

120: share Database (DB)

130: sales compensation processing part

### DESCRIPTION OF THE PREFERRED EMBODIMENTS

Preferred embodiments of the disclosure will now be described in detail with reference to the accompanying drawings. In the following description, the term “products” refers to items of commerce including digital content such as online music, movies, comics, images, software, and games.

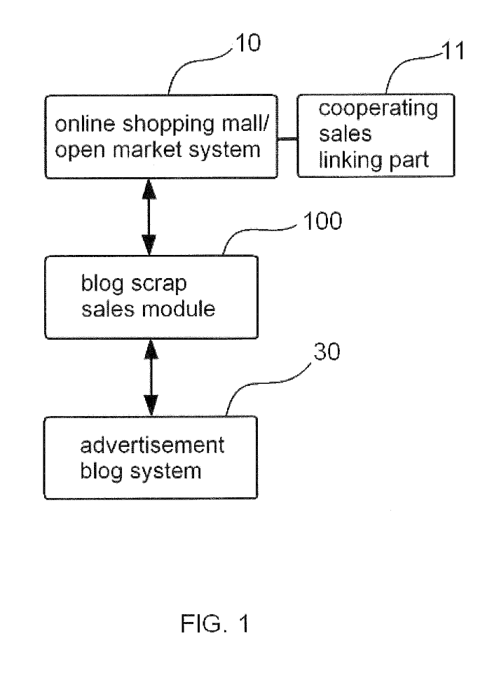

FIG. 1 is a block diagram illustrating the components of a system for selling products and content through a blog share sales module according to the disclosure. As shown in FIG. 1, the system includes an Internet shopping mall/open market system 10 and a marketing blog system 30, which are connected to a blog share sales module 100.

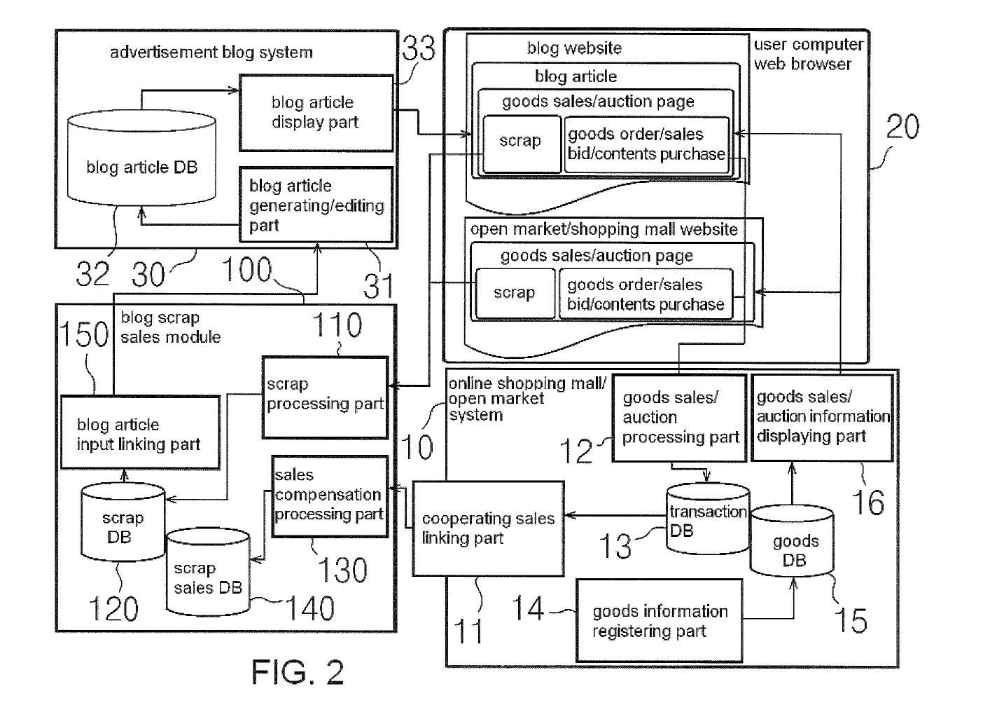

First, the Internet shopping mall/open market system 10 is described as follows with reference to FIGS. 1 and 2.

The Internet shopping mall/open market system 10 is a system which allows a product sales/auction page of an Internet shopping mall or open market, which is displayed on a user computer web browser 20, to be posted as a blog article in a marketing blog site to support direct product sales and auctions through the marketing blog site. In association with the electronic commerce operating method, the Internet shopping mall/open market system 10 is classified, according to the website operating method thereof, into two site operating systems, a shopping mall system which is operated by a single seller and an open market system in which a number of sellers participate, and is classified, according to the product type and sales method thereof, into a regular-price product sales system, an auction product sales system, and a content online-delivery sales system.

That is, the Internet shopping mall/open market system 10 according to the present disclosure is implemented as one of the shopping mall regular-price sales system, the shopping mall auction sales system, the open market regular-price sales system, the open market auction sales system, the shopping mall content online-delivery sales system, and the open market content online-delivery sales system.

As shown in FIG. 2, the Internet shopping mall/open market system 10 includes a cooperative sales linking unit 11, a product sales/auction processing unit 12, a transaction database (DB) 13, a product information registration unit 14, a product DB 15, and a product sales/auction information display unit 16.

The cooperative sales linking unit 11, which is a part of the Internet shopping mall/open market system 10, invokes a sales incentive processing unit 130 of the blog share sales module 100 and transmits transaction-related information to the blog share sales module 100 when a product sale/auction has been completed.

That is, the cooperative sales linking unit 11 is provided to transmit sales information to the blog share sales module 100. The blog share sales module 100 receives the sales information through the cooperative sales linking unit 11 and processes the received sales information at the sales incentive processing unit 130.

The product sales/auction processing unit 12 operates in the following manner. When a product is ordered using an order button 131 provided at one side of each product sales/auction page, the product sales/auction processing unit 12 stores order information of the ordered product in the transaction DB 13 and also transmits the order data to a delivery terminal so that the ordered product is delivered to the destination. When the ordered product is content, the product sales/auction processing unit 12 serves to deliver the content product to the purchaser by allowing the purchaser to download a file containing the corresponding content or to view or replay the corresponding content online.

When a confirmation of completion of the delivery of the ordered product is received from the purchaser or when a predetermined time has passed after delivery, the product sales/auction processing unit 12 decides to allow the proceeds of the sale of the product to be transferred to the seller of the product and determines whether or not the transaction has taken place on a product sales/auction page posted in the marketing blog site. When it is determined that the transaction has taken place on a product sales/auction page, the product sales/auction processing unit 12 retrieves information required for incentive for the blog-based sale, which is also referred to as “blog sale”, in the transaction DB 13 and transmits the retrieved information to the sales incentive processing unit 130 through the cooperative sales linking unit 11.

The transaction DB 13 stores order information of the product.

The product information registration unit 14 registers the Uniform Resource Locator (URL) of the product sales/auction page in which the product is present, and the price, seller email address, telephone number, and sales incentive information of the product and stores the same in the product DB 15.

The product sales/auction information display unit 16 serves to display product sales/auction information on the product sales/auction page of the Internet shopping mall or open market.

The following is a description of the blog share sales module 100 according to the present disclosure.

The blog share sales module 100 adds blogger identification information to the URL of the product sales/auction page and wraps the URL in iframe tags and then posts the wrapped URL as a blog article in the marketing blog site by operating in conjunction with a blog article generating/editing unit of a marketing blog system. The blog share sales module 100 then allows product sales and auctions to be performed directly through the product sales/auction page posted in the marketing blog site, and transfers, when the sale or auction has been completed, the sales incentive compensation to an email address of an individual who has posted the product sales/auction page as a blog article via an online payment system such as Paypal.

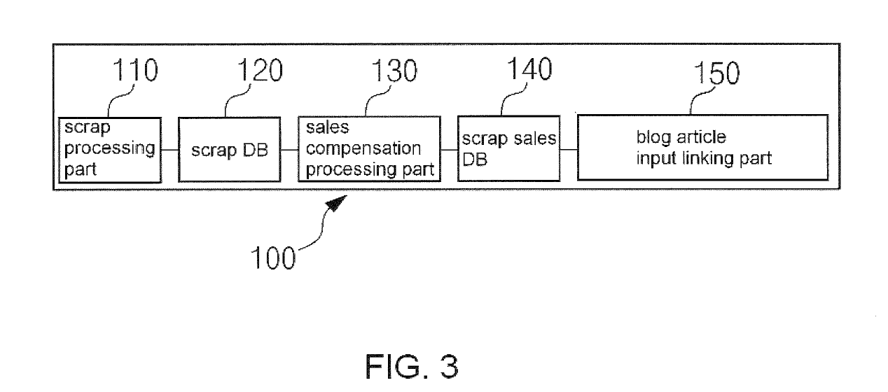

As shown in FIG. 3, the blog share sales module 100 includes a share processing unit 110, a share DB 120, a sales incentive processing unit 130, a share sales DB 140, and a blog article input linking unit 150.

The iframe tag is a tag which allows one web page to be placed in a small space in another page.

For example, when a product sales website, Interpark, is iframed, the tag source is written as <iframe scr=“http://www.interpark.co.kr” width=“500” height=“300”></iframe>.

The blog share sales module 100 according to the disclosure is installed and managed in a blog share sales (BSS) managing server.

The BSS managing server may be independently constructed and may also be implemented by installing the blog share sales module 100 in a server of an internet shopping mall/open market system which desires to provide blog share sales services.

The share processing unit 110 operates in the following manner. When a user clicks a share button 111 provided at one side of a product sales/auction page of an Internet shopping mall or open market to share (specifically, aggregate or extract) the product sales/auction page, the share processing unit 110 receives, from the user, the URL of the product sales/auction page, the user's email address, the URL of a blog, in which the user desires to post the product sales/auction page, and the user's ID and password and stores the received information in the share DB 120. The share processing unit 110 then invokes the blog article input liking unit 150 to post the product sales/auction page as a blog article via the blog article generating/editing unit in the marketing blog system.

Here, in order to discriminate between users who post the product sales/auction page in their blogs, each blogger's email address or a special parameter for identifying the blogger is added to the URL of the product sales/auction page and the added blogger's email address or special parameter is defined and stored, as a user identifier, in the share DB 120. A URL with a blogger identifier added thereto is also used for each product sales/auction page that is posted and displayed in a blog.

The share DB 120 stores the URL of each product sales/auction page, which is posted as a blog article through the share processing unit 110, and also stores, for each share of an article, share-related information such as the blogger's email address, the URL of the blog in which the article is posted, and the share date.

When the URL of the product sales/auction page is stored, a special identifier such as an email address that can be used to uniquely identify the user is added to the URL as described above. Accordingly, when a URL of a product sales/auction page with an identifier added thereto is posted or when transaction of a product has taken place in the product sales/auction page, each blogger who has posted the product sales/auction page can be identified even when different bloggers have posted the same product sales/auction page.

When a product sale or auction has been completed through a product sales/auction page which a blogger has posted as a blog article in the marketing blog site, the cooperative sales linking unit 11 of the Internet shopping mall/open market system 10 invokes the sales incentive processing unit 130 to transmit both information regarding the sales completion and information regarding billing of the sales incentive to the email address of the blogger or to transfer sales incentive compensation to the blogger via the online payment system.

Specifically, the blog share sales module 100 receives the product code, product name, price, and sales incentive information of the product sales/auction page from the Internet shopping mall/open market system 10 via the cooperative sales linking unit 11, and stores the same in the share sales DB 140 under the control of the sales incentive processing unit 130. Then the blog share sales module 100 searches the share DB 120 using the blogger identifier attached to the URL of the product sales/auction page to find an email address of a blogger who posted the product sales/auction page as a blog article. Then, the blog share sales module 100 transmits sales incentive compensation to the email address of the blogger via the online payment system, so that the blogger can receive the sales incentive compensation, or transmits a sales incentive billing guide to the blogger via an email address or an SMS message so that the blogger can bill the sales incentive compensation.

When transaction of a product has been completed in a product sales/auction page that a blogger has posted as a blog article, the share sales DB 140 stores the URL of the product sales/auction page, the blogger's email address, order date, the price of the product, blog sales incentive compensation, information indicating whether or not processing for sales incentive has been completed, etc.

The blog article input linking unit 150 links the blog share sales module 100 with the blog article generating/editing unit 31 of the marketing blog system 30 and allows a product sales/auction page to be posted as an article in the marketing blog site through the blog article generating/editing unit 31.

The blog article input linking unit 150 performs this process by invoking the blog article generating/editing unit 31 of the marketing blog system 30.

The blog article generating/editing unit 31 is provided in most blog systems including the marketing blog system 30. To allow the blog article generating/editing unit 31 to be linked with the blog share sales module 100, there is no need to make a special software change to the blog article generating/editing unit 31. Instead, the blog article input linking unit 150 is configured to suit the marketing blog system 30.

The marketing blog system 30 according to the disclosure serves to post each product sales/auction page, which has been shared as a blog article through the blog share sales module, in the marketing blog site to advertise the product sales/auction page. The marketing blog system 30 includes the blog article generating/editing unit 31, a blog article DB 32, and a blog article display unit 33.

The blog article generating/editing unit 31 generates a blog article in the marketing blog site and edits the contents of the article.

The blog article DB 32 stores all articles written to the marketing blog system 30. In an embodiment of the disclosure, the blog article DB 32 stores, for each share of an article, blog share-related information of each product sales/auction page, which has been produced and edited as a blog article, such as the URL of the product sales/auction page and personal identification information of the blogger.

The blog article display unit 33 displays articles, which have been stored in the blog article DB 32 via the blog article generating/editing unit 31 in the marketing blog system, on the window of the blog site. In an embodiment of the disclosure, the blog article display unit 33 displays, as a blog article, the URL of the product sales/auction page which has been produced and edited as one blog article.

In association with the electronic commerce operating method, the sales website is classified into a shopping mall which is operated by a single seller and an open market in which a number of sellers participate, and the product type and sales method is classified into a regular-price product sales method, an auction product sales method, and a content online-delivery sales method. Websites for selling content such as online music, movies, comics, images, software, and games can also be classified, by the website operating method, into shopping malls and open markets.

Accordingly, the components of the blog share sales module according to the disclosure may be configured as components of a “Shopping mall Regular (SR)” type associated with the shopping mall regular-price sales system, a “Shopping mall Auction (SA)” type associated with the shopping mall auction sales system, an “Open mall Regular (OR)” type associated with the open market regular-price sales system, an “Open market Auction (OA)” type associated with the open market auction sales system, a “Shopping mall Content (SC)” type associated with the shopping mall content online-delivery sales system, or an “Open market Content (OC)” type associated with the open market content online-delivery sales system.

This can be summarized as the following Table 1.

TABLE 1

| Goods and sales method | Shopping mall | Open market |
|---|---|---|
| Goods regular-price sales (Regular) | SR | OR |
| Goods auction sales (Auction) | SA | OA |
| Contents online delivery sales (Contents) | SC | OC |

A Shopping Mall Regular Price Sales System (SR Type): Blog Share Sales Process.

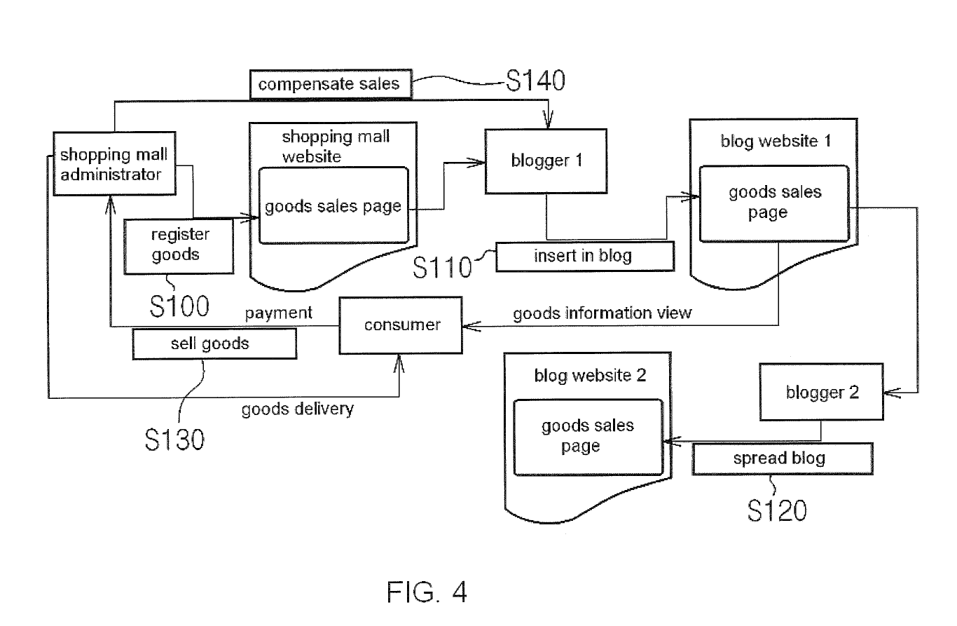

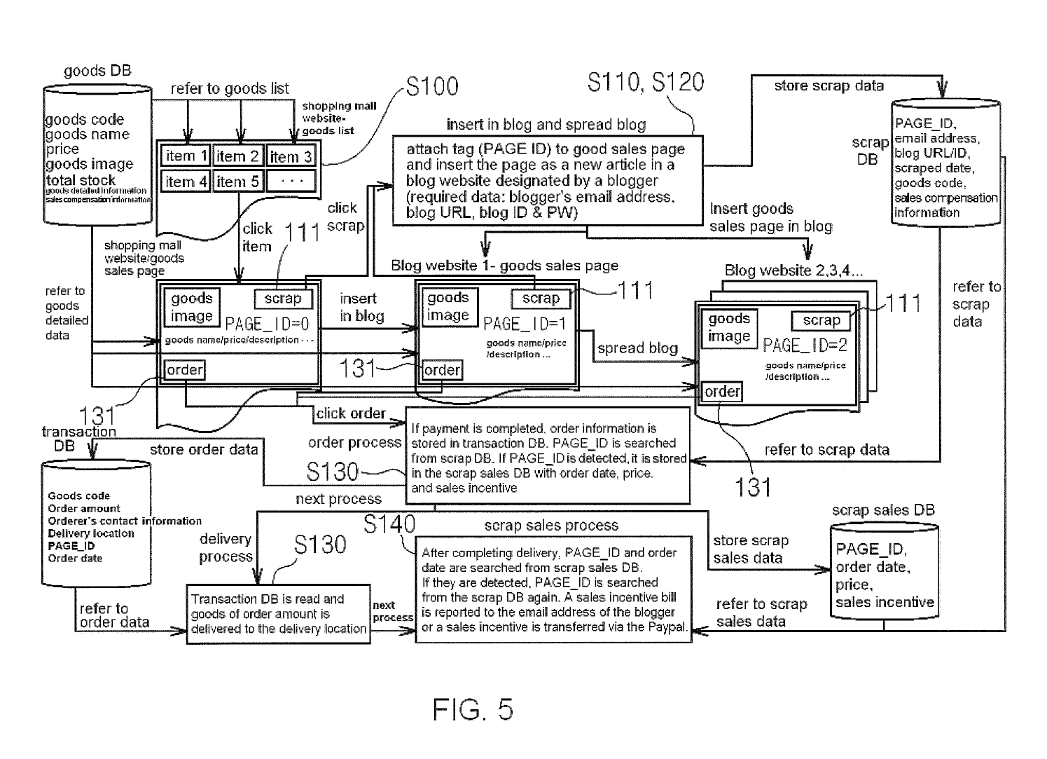

FIG. 4 is a block diagram illustrating a method for selling products through a blog share sales module in an Internet shopping mall regular-price sales system (SR type system) according to the disclosure, and FIG. 5 is a process diagram illustrating a method for selling products through a blog share sales module in an Internet shopping mall regular-price sales system according to the disclosure.

First, product information and blog sales incentive information are registered in the Internet shopping mall regular-price sales system (SR type system) including a blog share sales module (S100).

Specifically, an internet shopping mall provider uploads product information such as a product list, prices, and product descriptions to an Internet shopping mall that supports the blog share sales functionality and then inputs agency sales incentive information regarding blog share sales.

The product information and the agency sales incentive information are then exposed to users through a product sales page, which is programmed to provide electronic commerce functionality, in the Internet shopping mall site.

Then, under control of the blog share sales module, a user checks product information and blog sales incentive information registered in the Internet shopping mall regular-price sales system (SR type system) and posts a sales page of a product corresponding to the checked information as an article in a blog and an email address of a user who has posted the article in the blog, the posting date of the blog article, and the posting location of the sales page are stored in a share DB 120 for the SR type system, which will hereinafter be referred to as an “SR share DB” for short (S110).

Specifically, a blogger checks product information and sales agency incentive information regarding blog share sales registered in a product sales page of an Internet shopping mall regular-price sales website.

Then, using a user interface including a button or the like that is provided to allow a product sales page to be posted (or shared) as a blog article, the blogger posts the product sales page, as an article, in a blog to which the blogger has access permission.

The share processing unit that is linked with the button receives personal identification information such as an email address or a mobile phone number, which can be used to identify the blogger, and then stores the received information in the BSS management server together with a URL of the blog or URL information of the article in which the product sales page is contained.

Then, a blog sharer copies (i.e., shares) the product sales page as an article to a desired marketing blog site using a share button provided at one side of the product sales page posted in the blog, and an email address of the blog sharer and the share date and the share location of the blog article are stored in the SR share DB 120 to disseminate the blog article (S120).

Specifically, the URL of the product sales page is transmitted to a blog article generating/editing unit for a desired marketing blog site through the blog article input linking unit and is then registered as a blog article, so that the product sales page is displayed within the blog article.

A third blogger checks the product sales page posted in the blog and checks product information and sales agency incentive information regarding blog sales registered for the product sales page.

Then, using a user interface including a button or the like that is provided to allow the product sales page to be posted (or shared) as a blog article, the third blogger posts the product sales page, as an article, in a blog to which the third blogger has access permission.

In this manner, bloggers disseminate product sales pages exposed to the Internet to a variety of blogs.

Since personal identification information of a blogger who has posted the product sales page is also stored in the SR share DB in the BSS module each time the product sales page is posted in a blog, it is possible to track who has posted the product sales page on which blog. The personal identification information is used to identify a sales incentive recipient when a transaction has taken place in the product sales page posted in a blog.

Then, through a program linked with an order button provided at one side of the product sales page posted as an article in the marketing blog site, order information of a product that is ordered through the button, the page URL, order date, price, and blog sales incentive information of the ordered product are stored in the SR share DB and the ordered product is then delivered to the destination (S130).

That is, when a purchaser views a product sales page posted as a blog article and orders a product using an order button provided at one side of the product sales page, the SR product sales processing unit linked with the order button stores order information of the product and also transmits the order data to a delivery terminal so that the ordered product is delivered to a destination.

If a purchaser purchases a product through a product sales page posted as an article in a blog using an order button programmed to provide electronic commerce functionality, the product sales processing unit of the shopping mall system assigns a unique transaction number to this transaction and stores sales information such as the purchase date, product name, and price of the purchased product, together with a URL of the blog (or a URL of the article containing the product sales page), in a transaction DB for the SR type system, which will hereinafter be referred to as an “SR transaction DB” for short.

The ordered product stored in the SR transaction DB is searched for in the product DB of the Internet shopping mall system and then an instruction to deliver an ordered number of items of the product to the destination is transmitted to the delivery terminal, so that the delivery person delivers the ordered product to the destination.

Then, through the sales incentive processing unit of the blog share sales module, it is checked whether or not payment and delivery for the product purchase and the blog sales have been completed, sales incentive billing information is transmitted to the email address of the blog sharer, or blog sales incentive compensation is transferred to the blog sharer via an online payment system such as Paypal, or a sales incentive billing guide is transmitted to the blog sharer (S140).

Specifically, when it is determined that product delivery has been completed, the Internet shopping mall system controls the sales incentive processing unit of the blog share sales module through the cooperative sales linking unit 11 to perform a process for providing sales incentive to the blogger who has posted the product sales page in a blog.

After the transaction has been completed, the sales incentive processing unit according to the present disclosure receives a unique transaction number, a URL of the product sales page, and the order date via the cooperative sales linking unit 11 and searches for the product sales page URL in the share DB to find the email address of an individual who has posted the product sales page as a blog article. The sales incentive processing unit then transmits a guide for billing blog sales incentive compensation to the email address or transfers blog sales incentive compensation thereto via the online payment system.

The blog sales incentive compensation may be paid to the blogger not only through the online payment system but also through wire transfer, cyber money payment, provision of a predetermined product or service, etc.

The share sales DB stores the blogger's email address used for the sales incentive, information indicating whether or not incentive compensation has been paid, a payment date, a payment method, a URL of the sales page posted as a blog article, a unique transaction number, etc.

A Shopping Mall Auction Sales System (SA Type): Blog Share Sales Process.

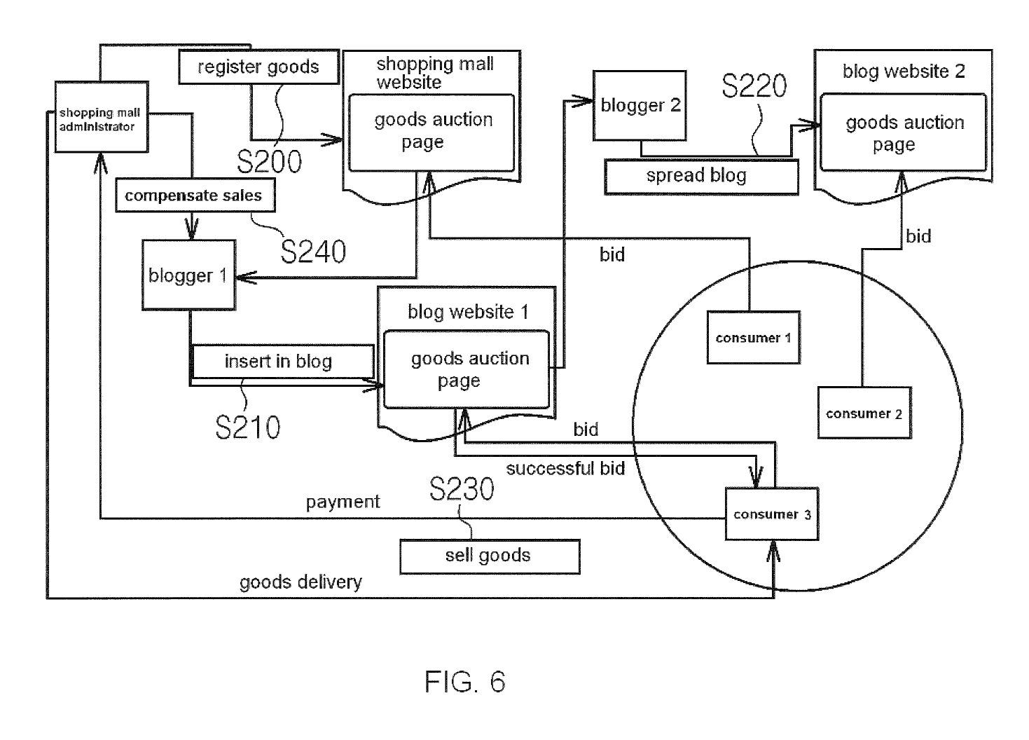

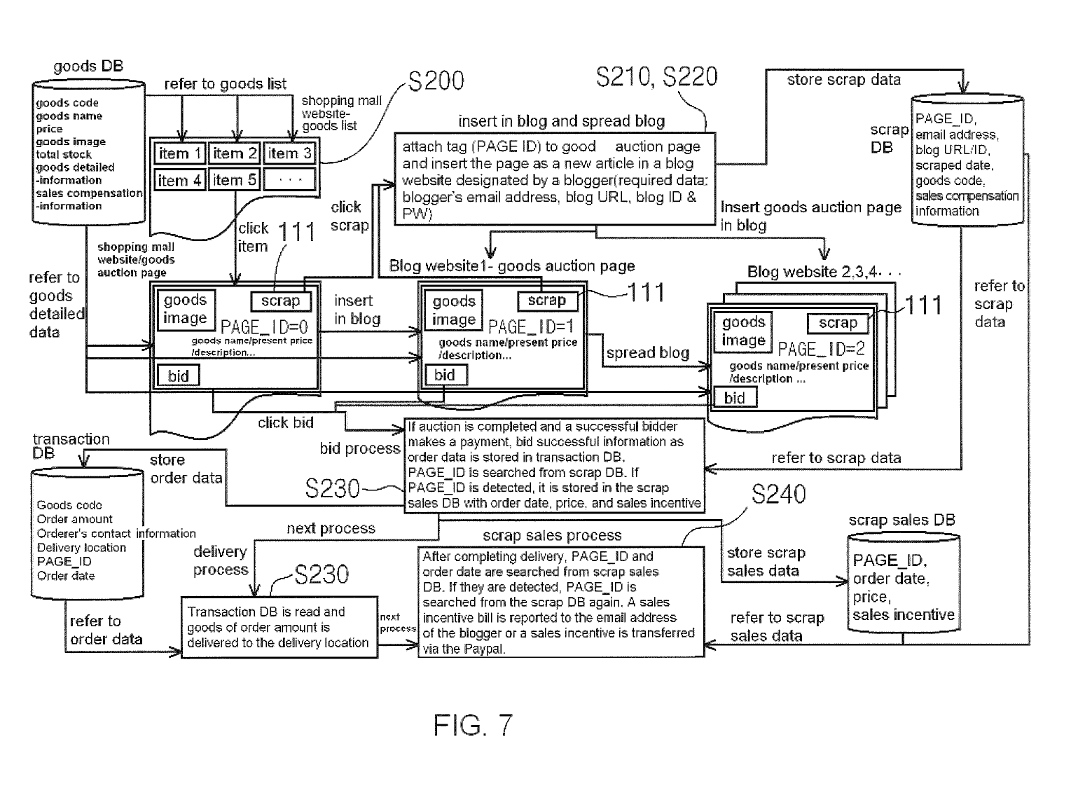

FIG. 6 is a block diagram illustrating a method for selling products through a blog share sales module in an Internet shopping mall auction sales system (SA type system) according to the present disclosure, and FIG. 7 is a process diagram illustrating a method for selling products through a blog share sales module in an Internet shopping mall auction sales system according to the present disclosure.

First, product information and blog sales incentive information are registered in the Internet shopping mall auction sales system (SA type system) including a blog share sales module (S200).

Specifically, an internet shopping mall provider uploads auction product information such as an auction product list, auction prices, and auction product descriptions to an Internet shopping mall auction site that supports the blog share sales functionality and then inputs agency sales incentive information regarding blog share sales.

The auction product information and the agency sales incentive information are then exposed to users through a product auction page, which is programmed to provide electronic commerce functionality, in the Internet shopping mall auction site.

Then, under control of the blog share sales module, a user checks product information and blog sales incentive information registered in the Internet shopping mall auction sales system (SA type system) and posts an auction page of a product corresponding to the checked information as an article in a blog and an email address of a user who has posted the article in the blog, the posting date of the blog article, and the posting location of the auction page are stored in a share DB 120 for the SA type system, which will hereinafter be referred to as an “SA share DB” for short (S210).

Specifically, a blogger checks auction product information and sales agency incentive information regarding blog share sales registered in a product auction page of an Internet shopping mall auction sales website.

Then, using a user interface including a button or the like that is provided to allow the product auction page to be shared as a blog article, the blogger posts the product auction page, as an article, in a blog to which the blogger has access permission.

The share processing unit that is linked with the button receives personal identification information such as an email address or a mobile phone number, which can be used to identify the blogger, and then stores the received information in the BSS management server together with a URL of the blog or URL information of the article in which the product auction page is contained.

Then, a blog sharer copies (i.e., shares) the product auction page as an article to a desired marketing blog site using a share button provided at one side of the product auction page posted in the blog, and an email address of the blog sharer and the share date and the share location of the blog article are stored in the SA share DB 120 to disseminate the blog article (S220).

Specifically, the URL of the product auction page is transmitted to a blog article generating/editing unit for a desired marketing blog site through the blog article input linking unit and is then registered as a blog article, so that the product auction page is displayed within the blog article.

A third blogger checks the product auction page posted in the blog and checks product information and sales agency incentive information regarding blog sales registered for the product auction page.

Then, using a user interface including a button or the like that is provided to allow the product auction page to be posted (or shared) as a blog article, the third blogger posts the product auction page, as an article, in a blog to which the third blogger has access permission.

In this manner, bloggers disseminate product auction pages exposed to the Internet to a variety of blogs.

Since personal identification information of a blogger who has posted the product auction page is also stored in the SA share DB in the BSS module each time the product auction page is posted in a blog, it is possible to track who has posted the product auction page on which blog. The personal identification information is used to identify a sales incentive recipient when a transaction has taken place in the product auction page posted in a blog.

Then, when users have bid on a product using a bid button provided at one side of the product auction page posted as an article in the marketing blog site, a successful bidder is selected from among qualified bidders based on the highest bid price through a program linked with the bid button and successful bid information of the sold product is stored in the SA share sales DB. In addition, the URL of the auction page, the successful bid date, the successful bid price, and blog sales incentive information of the product are also stored in the SA share sales DB and the product is then delivered to the destination (S230).

Specifically, when a user has made a bid on a product through a bid button provided at one side of an auction product sales page of the marketing blog site, the SA product sales processing unit linked with the bid button stores bid information of the product such as a page ID, a bid date, a bid price, and blog sales incentive compensation of the product and transmits the successful bid data to a delivery terminal so that the sold product is delivered to the destination.

That is, when users have bid on a product in a blog using a bid button programmed to provide auction functionality, the Internet shopping mall system selects a successful bidder from among qualified bidders based on the highest bid price and stores successful bid information of the product such as a unique auction number, a successful bid date, a product name, the successful bid price, together with a URL of the blog (or a URL of an article containing the web content), in the SA transaction DB.

The ordered product in the SA transaction DB is searched for in the product DB of the Internet shopping mall system and then an instruction to deliver the ordered product to the destination is transmitted to the delivery terminal, so that the delivery person delivers the ordered product to the destination.

Then, through the controller of the blog share sales module, it is checked whether or not payment and delivery for the product purchase and the blog sales have been completed, sales incentive billing information is transmitted to the email address of the blog sharer, or blog sales incentive compensation is transferred to the blog sharer via an online payment system such as Paypal, or a sales incentive billing guide is transmitted to the blog sharer (S240).

Specifically, when it is determined that product delivery has been completed, the Internet shopping mall system controls the sales incentive processing unit of the blog share sales module through the cooperative sales linking unit 11 to perform a process for providing sales incentive to the blogger who has posted the product auction page in a blog.

After the transaction has been completed, the sales incentive processing unit according to the present disclosure receives a unique transaction number, a URL of the product auction page, and the order date via the cooperative sales linking unit 11 and searches for the product auction page URL in the share DB to find the email address of an individual who has posted the product auction page as a blog article. The sales incentive processing unit then transmits a guide for billing blog sales incentive compensation to the email address or transfers blog sales incentive compensation thereto via the online payment system.

The blog sales incentive compensation may be paid to the blogger not only through the online payment system but also through wire transfer, cyber money payment, provision of a predetermined product or service, etc.

The share sales DB stores the blogger's email address used for the sales incentive, information indicating whether or not incentive compensation has been paid, a payment date, a payment method, a URL of the auction page posted as a blog article, a unique transaction number, etc.

An Open Market Regular-Price Sales System (OR type): Blog Share Sales Process.

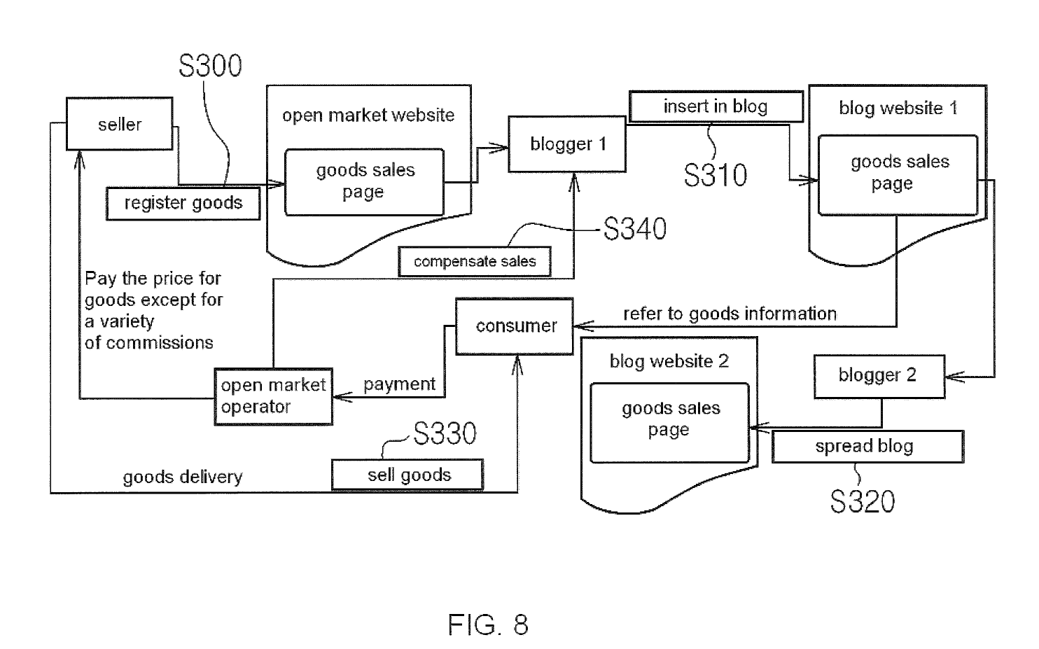

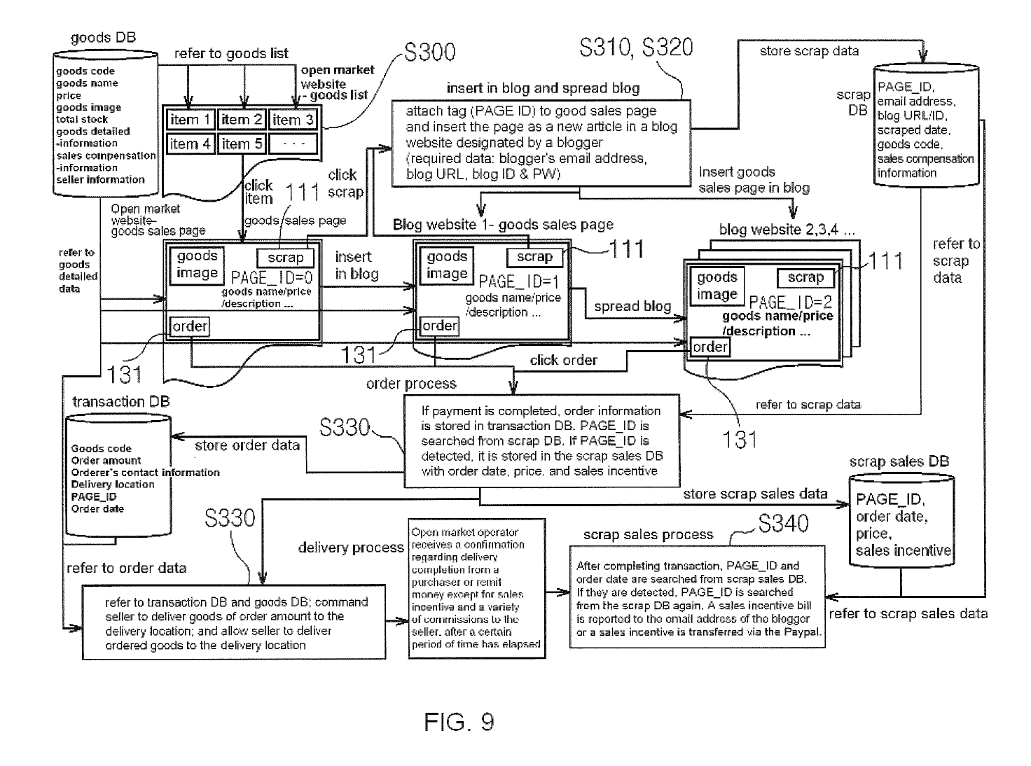

FIG. 8 is a block diagram illustrating a method for selling products through a blog share sales module in an open market regular-price sales system (OR type system) according to the present disclosure, and FIG. 9 is a process diagram illustrating a method for selling products through a blog share sales module in an open market regular-price sales system according to the present disclosure.

First, product information and blog sales incentive information are registered in the open market regular-price sales system (OR type system) including a blog share sales module (S300).

Specifically, an open market provider uploads product information such as a product list, prices, and product descriptions to an open market regular-price sales site that supports the blog share sales functionality and then inputs agency sales incentive information regarding blog share sales.

The product information and the agency sales incentive information are then exposed to users through a product sales page, which is programmed to provide electronic commerce functionality, in the open market site.

Then, under control of the blog share sales module, a user checks product information and blog sales incentive information registered in the open market regular-price sales system (OR type system) and posts a sales page of a product corresponding to the checked information as an article in a blog and an email address of a user who has posted the article in the blog, the posting date of the blog article, and the posting location of the sales page are stored in a share DB 120 for the OR type system, which will hereinafter be referred to as an “OR share DB” for short (S310).

Specifically, a blogger checks product information and sales agency incentive information regarding blog share sales registered in a product sales page of an open market regular-price sales website.

Then, using a user interface including a button or the like that is provided to allow the product sales page to be shared as a blog article, the blogger posts the product sales page, as an article, in a blog to which the blogger has access permission.

The share processing unit that is linked with the button receives personal identification information such as an email address or a mobile phone number, which can be used to identify the blogger, and then stores the received information in the BSS management server together with a URL of the blog or URL information of the article in which the product sales page is contained.

Then, a blog sharer copies (i.e., shares) the product sales page as an article to a desired marketing blog site using a share button provided at one side of the product sales page posted in the blog, and an email address of the blog sharer and the share date and the share location of the blog article are stored in the OR share DB 120 to disseminate the blog article (S320).

Specifically, the URL of the product sales page is transmitted to a blog article generating/editing unit for a desired marketing blog site through the blog article input linking unit and is then registered as a blog article, so that the product sales page is displayed within the blog article.

A third blogger checks the product sales page posted in the blog and checks product information and sales agency incentive information regarding blog sales registered for the product sales page.

Then, using a user interface including a button or the like that is provided to allow the product sales page to be posted (or shared) as a blog article, the third blogger posts the product sales page, as an article, in a blog to which the third blogger has access permission.

In this manner, bloggers disseminate product sales pages exposed to the Internet to a variety of blogs.

Since personal identification information of a blogger who has posted the product sales page is also stored in the OR share DB in the BSS module each time the product sales page is posted in a blog, it is possible to track who has posted the product sales page on which blog. The personal identification information is used to identify a sales incentive recipient when a transaction has taken place in the product sales page posted in a blog.

Then, through a program linked with an order button provided at one side of the product sales page posted as an article in the marketing blog site, order information of a product that is ordered through the button, the page URL, order date, price, and blog sales incentive information of the ordered product are stored in the OR share sales DB and the order data is transmitted to the seller so that the ordered product is delivered to the destination (S330).

Specifically, if a purchaser purchases a product through a product sales page posted as an article in a blog using an order button programmed to provide electronic commerce functionality, the product sales processing unit of the open market system assigns a unique transaction number to this transaction and stores sales information such as the purchase date, product name, and price of the purchased product, together with a URL of the blog (or a URL of the article containing the product sales page), in a transaction DB for the OR type system, which will hereinafter be referred to as an “OR transaction DB” for short.

The ordered product in the OR transaction DB is searched for in the product DB of the open market system and then an instruction to deliver the ordered product to the destination is transmitted to the delivery terminal, so that the seller who has registered the product in the open market delivers the ordered product to the destination.

Then, through the sales incentive processing unit of the blog share sales module, it is checked whether or not payment and delivery for the product purchase and the blog sales have been completed, sales incentive billing information is transmitted to the email address of the blog sharer, or blog sales incentive compensation is transferred to the blog sharer via an online payment system such as Paypal, or a sales incentive billing guide is transmitted to the blog sharer (S340).

Specifically, when it is determined that product delivery has been completed, the open market system controls the sales incentive processing unit of the blog share sales module through the cooperative sales linking unit 11 to perform a process for providing sales incentive to the blogger who has posted the product sales page in a blog.

After the transaction has been completed, the sales incentive processing unit according to the present disclosure receives a unique transaction number, a URL of the product sales page, and the order date via the cooperative sales linking unit 11 and searches for the product sales page URL in the share DB to find the email address of an individual who has posted the product sales page as a blog article. The sales incentive processing unit then transmits a guide for billing blog sales incentive compensation to the email address or transfers blog sales incentive compensation thereto via the online payment system.

The blog sales incentive compensation may be paid to the blogger not only through the online payment system but also through wire transfer, cyber money payment, provision of a predetermined product or service, etc.

The share sales DB stores the blogger's email address used for the sales incentive, information indicating whether or not incentive compensation has been paid, a payment date, a payment method, a URL of the sales page posted as a blog article, a unique transaction number, etc.

The proceeds of the sale of the product, less the blog share sales incentive compensation and a variety of fees and expenses due to use of the open market system, are transferred to the seller.

An Open Market Auction Sales System (OA type system): Blog Share Sales Process.

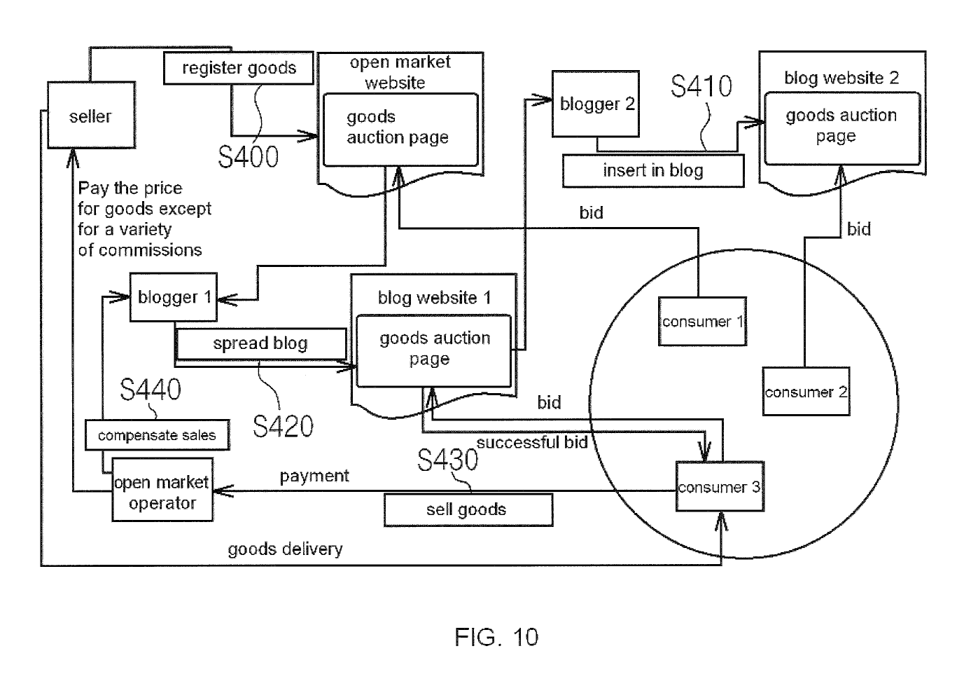

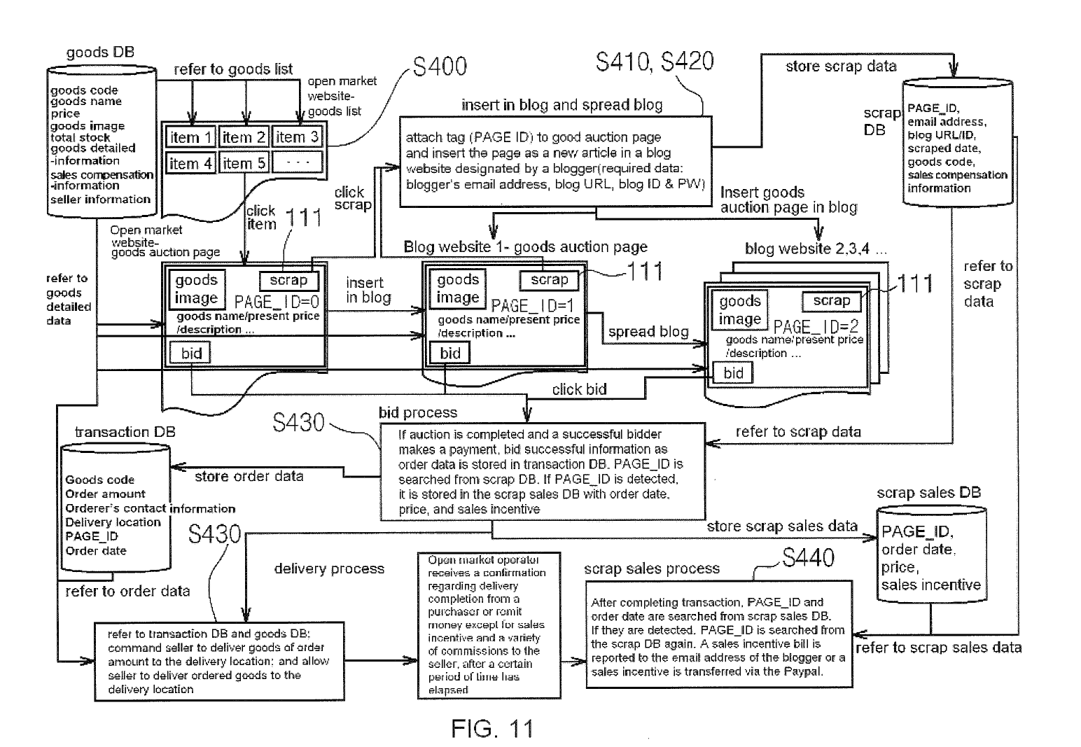

FIG. 10 is a block diagram illustrating a method for selling products through a blog share sales module in an Open market auction sales system (OA type system) according to the present disclosure, and FIG. 11 is a process diagram illustrating a method for selling products through a blog share sales module in an Open market auction sales system according to the present disclosure.

First, product information and blog sales incentive information are registered in the Open market auction sales system (OA type system) including a blog share sales module (S400).

Specifically, an open market provider uploads auction product information such as an auction product list, auction prices, and auction product descriptions to an open market auction site that supports the blog share sales functionality and then inputs agency sales incentive information regarding blog share sales.

The auction product information and the agency sales incentive information are then exposed to users through a product auction page, which is programmed to provide electronic commerce functionality, in the open market auction site.

Then, under control of the blog share sales module, a user checks product information and blog sales incentive information registered in the Open market auction sales system (OA type system) and posts an auction page of a product corresponding to the checked information as an article in a blog and an email address of a user who has posted the article in the blog, the posting date of the blog article, and the posting location (i.e., URL) of the auction page are stored in a share DB 120 for the OA type system, which will hereinafter be referred to as an “OA share DB” for short (S410).

Specifically, a blogger checks auction product information and sales agency incentive information regarding blog share sales registered in a product auction page of an Open market auction sales website.

Then, using a user interface including a button or the like that is provided to allow the product auction page to be shared as a blog article, the blogger posts the product auction page, as an article, in a blog to which the blogger has access permission.

The share processing unit that is linked with the button receives personal identification information such as an email address or a mobile phone number, which can be used to identify the blogger, and then stores the received information in the BSS management server together with a URL of the blog or URL information of the article in which the product auction page is contained.

Then, a blog sharer copies (i.e., shares) the product auction page as an article to a desired marketing blog site using a share button provided at one side of the product auction page posted in the blog, and an email address of the blog sharer and the share date and the share location of the blog article are stored in the OA share DB 120 to disseminate the blog article (S420).

Specifically, the URL of the product auction page is transmitted to a blog article generating/editing unit for a desired marketing blog site through the blog article input linking unit and is then registered as a blog article, so that the product auction page is displayed within the blog article.

A third blogger checks the product auction page posted in the blog and checks product information and sales agency incentive information regarding blog sales registered for the product auction page.

Then, using a user interface including a button or the like that is provided to allow the product auction page to be posted (or shared) as a blog article, the third blogger posts the product auction page, as an article, in a blog to which the third blogger has access permission.

In this manner, bloggers disseminate product auction pages exposed to the Internet to a variety of blogs.

Since personal identification information of a blogger who has posted the product auction page is also stored in the OA share DB in the BSS module each time the product auction page is posted in a blog, it is possible to track who has posted the product auction page on which blog. The personal identification information is used to identify a sales incentive recipient when a transaction has taken place in the product auction page posted in a blog.

Then, when users have bid on a product using a bid button provided at one side of the product auction page posted as an article in the marketing blog site, a successful bidder is selected from among qualified bidders based on the highest bid price through a program linked with the bid button and successful bid information of the sold product is stored. In addition, the URL of the auction page, the successful bid date, the successful bid price, and blog sales incentive information of the product are also stored in the OA share sales DB and the order data is transmitted to the seller so that the sold product is delivered to the destination (S430).

That is, when users have bid on a product in a blog using a bid button programmed to provide auction functionality, the open market system selects a successful bidder from among qualified bidders based on the highest bid price and stores successful bid information of the product such as a unique auction number, a successful bid date, a product name, the successful bid price, together with a URL of the blog (or a URL of an article containing the web content), in the OA transaction DB.

The ordered product in the OA transaction DB is searched for in the product DB of the open market system and then an instruction to deliver the ordered product to the destination is transmitted to the delivery terminal, so that the seller who has registered the product in the open market delivers the ordered product to the destination.

Then, through the sales incentive processing unit of the blog share sales module, it is checked whether or not payment and delivery for the product purchase and the blog sales have been completed, sales incentive billing information is transmitted to the email address of the blog sharer, or blog sales incentive compensation is transferred to the blog sharer via an online payment system such as Paypal, or a sales incentive billing guide is transmitted to the blog sharer (S440).

Specifically, when it is determined that product delivery has been completed, the open market system controls the sales incentive processing unit of the blog share sales module through the cooperative sales linking unit 11 to perform a process for providing sales incentive to the blogger who has posted the product auction page in a blog.

After the transaction has been completed, the sales incentive processing unit according to the present disclosure receives a unique transaction number, a URL of the product auction page, and the order date via the cooperative sales linking unit 11 and searches for the product auction page URL in the share DB to find the email address of an individual who has posted the product auction page as a blog article. The sales incentive processing unit then transmits a guide for billing blog sales incentive compensation to the email address or transfers blog sales incentive compensation thereto via the online payment system.

The blog sales incentive compensation may be paid to the blogger not only through the online payment system but also through wire transfer, cyber money payment, provision of a predetermined product or service, etc.

The share sales DB stores the blogger's email address used for the sales incentive, information indicating whether or not incentive compensation has been paid, a payment date, a payment method, a URL of the auction page posted as a blog article, a unique transaction number, etc.

The proceeds of the sale of the product, less the blog share sales incentive compensation and a variety of fees and expenses due to use of the open market system, are transferred to the seller.

A Shopping Mall Contents Online Delivery Sales System (SC type): Blog Share Sales Process.

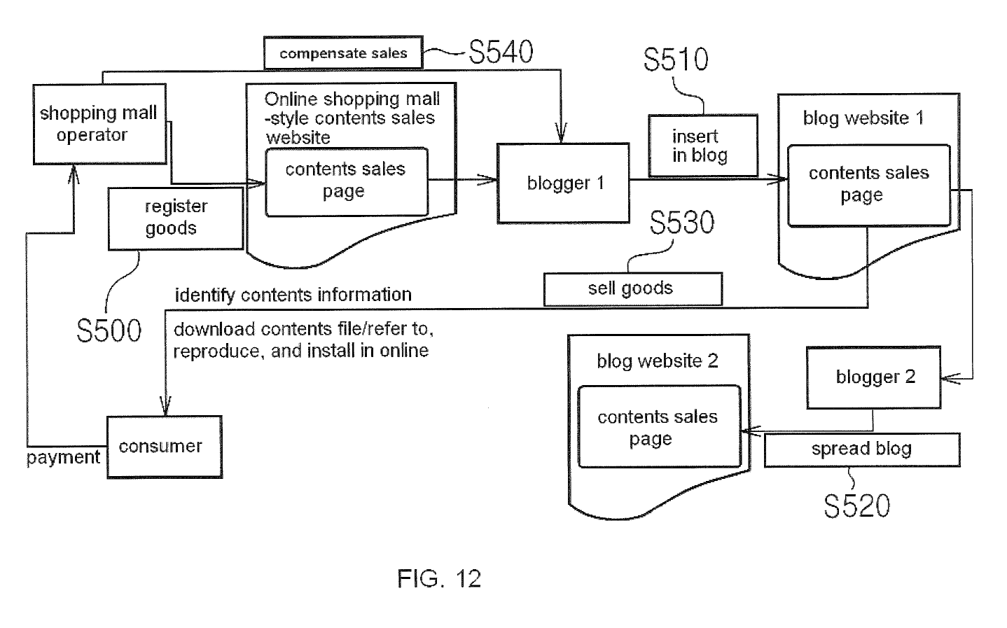

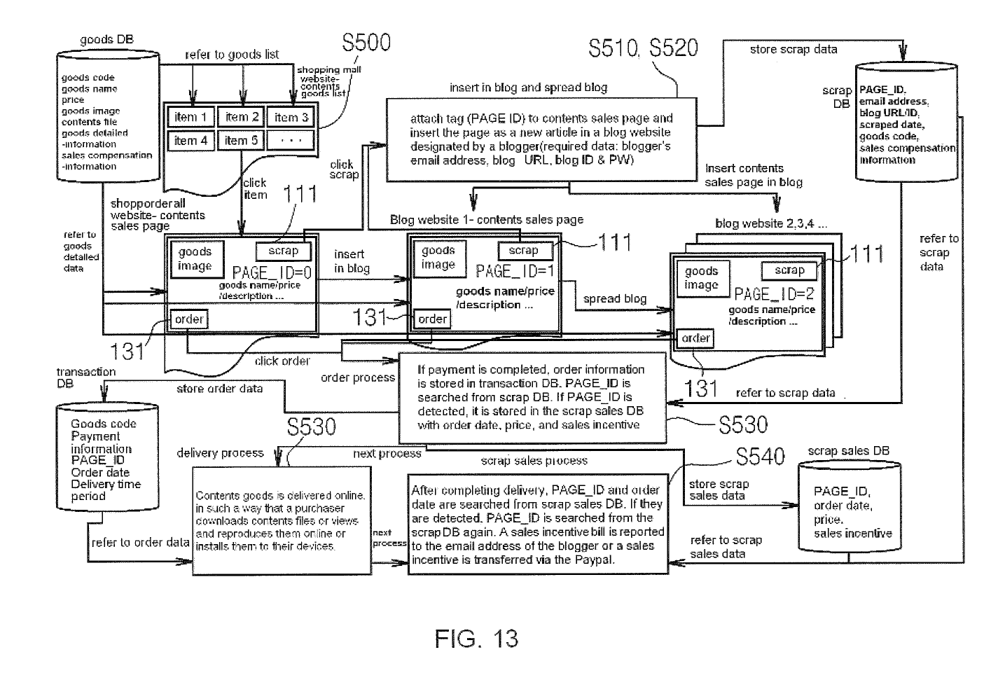

FIG. 12 is a schematic block diagram describing a method for selling goods through a blog share sales module in a shopping mall contents online delivery sales system (SC type) according to an embodiment of the present disclosure. FIG. 13 is a detailed block diagram describing a method for selling goods through a blog share sales module in a shopping mall contents online delivery sales system (SC type) according to an embodiment of the present disclosure.

Contents goods information, blog sales compensation information, and digital contents files to be sold, such as music, movies, moving images, images, comics, software, games, etc., are registered in the Internet shopping mall contents online delivery sales system (SC type) including a blog share sales module (S500).

A digital contents sales provider uploads contents goods information, such as a list of contents, prices, contents description, etc., in a contents sales website that can support a blog share sales function, and then inputs agency sales compensation information regarding blog share sales.

The contents goods information and agency sales compensation information refers to web contents that are programmed to have an electronic commercial function in the Internet shopping mall website, and is exposed to users.

Next, the blog share sales module checks contents goods information and blog sales compensation information, registered in the Internet shopping mall contents online delivery sales system (SC type), inserts a sales page of a corresponding content, as an article, in a blog, and stores an email address of a user who inserts the article in the blog, a date of blog article insertion, and a sales page inserted location in the share DB 120 for the SC type system (S510).

That is, the blogger checks the registered contents goods information and sales agency compensation information regarding blog share sales in the goods sales page of the contents sales website.

After that, using user interfaces, such as buttons, to insert (share) an article in a blog, a contents sales page is inserted, as an article, in a blog that has a proper access right.

The share processing part associated with buttons receives personal recognition information such as an email address or a mobile phone number, which is used to identify a blogger, and then stores it in the BSS management server with a blog URL or information regarding a URL of an article where a contents sales page is contained.

After that, the contents sales page is copied as an article in an advertisement blog website by using a share button located at one side of the contents sales page inserted in the blog, and an email address of a blogger, a blog shared date, and a blog sharing location are stored in the SC share DB 120 to spread the blog (S520).

That is, the URL of the contents sales page is transmitted to the blog article producing/editing part of the advertisement blog website through the blog article input linking part and registered as a blog article, so that the contents sales page is displayed through the blog article.

A third blogger checks the contents sales page inserted in the blog. The third blogger also checks registered contents goods information and sales agency compensation information regarding blog sales.

Using a user interface, such as a button, etc., prepared to insert (share) pages as an article in a blog, a contents sales page is inserted as an article in a blog that has a proper access right.

As such, contents sales pages disclosed in the Internet space can be spread to a variety of blog websites by a plurality of bloggers.

Since personal recognition information of a blogger who performs an insertion is stored in the SC share DB of a BBS module each time a goods sales page is inserted in a blog, the goods sales page can be tracked via the individuals who insets the pages in to various blogs. The personal recognition information can be used to identify a sales compensation beneficiary when a transaction has occurred in the contents sales page inserted in a blog.

After that, through a program associated with an order button located at one side of the contents sales page inserted as an article in the advertisement blog website, order information regarding a corresponding contents, a URL of the ordered contents item page, order date, price, and blog sales compensation information are stored in the SC share DB, and the corresponding contents are provided to the orderer by file download, online reference, online playback, or online installation (S530).

That is, when a contents purchaser purchases content using the order button that is programmed to have an electronic commercial function in a blog, the goods sales processing part of the Internet shopping mall system assigns a unique transaction number thereto and stores sales information, such as a sales date, a list of items, price, etc., and a blog URL (or a URL of an article containing contents sales page) in the transaction DB for the SC type system.

An ordered contents item in transaction DB for the SC type system, and corresponding content, searched from the goods DB of the Internet shopping mall system, are provided to the orderer by file download, online reference, online playback, or online installation.

The sales compensation processing part of the blog share sales module determines whether a purchase payment and a delivery completion, according to item purchase and blog sales, are performed. After that, bill information regarding sales compensation is transmitted to an email address of a blogger, blog sales compensation money is transferred to a blogger via the online payment system, or a guide message regarding sales compensation bill is transmitted to a blogger (S540).

That is, after contents provision has been completed, the cooperation sales linking part 11 controls the sales compensation processing part of the blog share sales module to process sales compensation to the blogger who inserted the contents sales page in a blog.

In an embodiment of the present disclosure, after the transaction has been completed, the sales compensation processing part receives a unique number of a corresponding transaction, a contents sales page URL, and order date via the cooperation sales linking part 11 and searches the contents sales page URL from the share DB to seek an email address of a blogger who inserted the page in a blog. After that, the sales compensation processing part transmits a blog sales compensation money bill guide to the email or transfers blog sales compensation money thereto via the online payment system.

In an embodiment of the present disclosure, the blog sales compensation money is paid to a corresponding blogger with the online payment system. It should be, however, understood that the payment of the blog sales compensation money may be performed by cash transfer, cyber money, and predetermined goods or services.

In an embodiment of the present disclosure, the share sales DB stores bloggers' email addresses used for sales compensation, a state whether compensation money is paid, a payment date, a payment method, a URL of a sales page inserted as a blog article, a transaction unique number, etc.

An Open Market Contents Online Delivery Sales System (OC type): Blog Share Sales Process

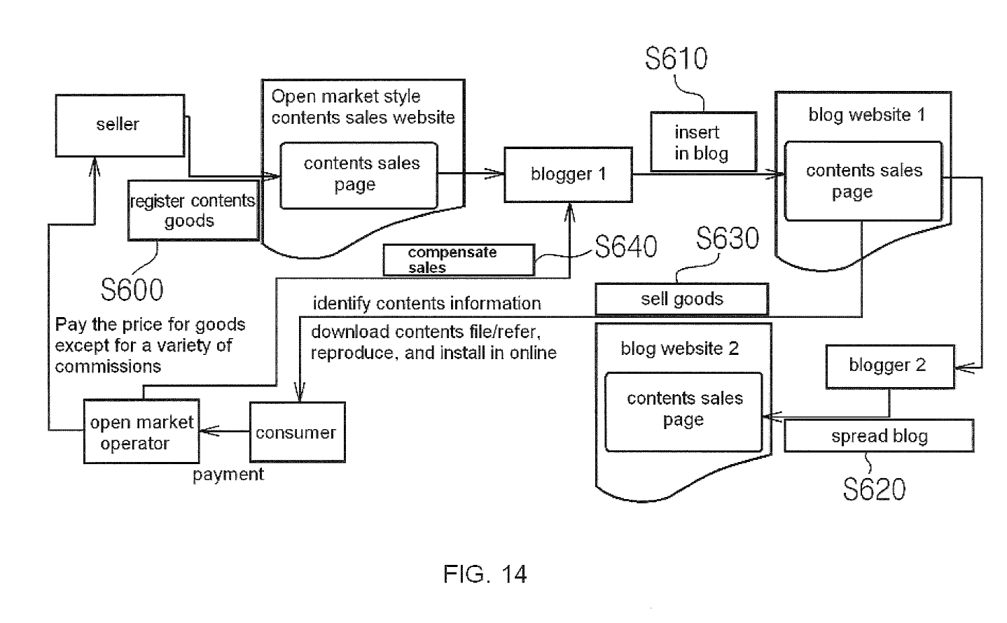

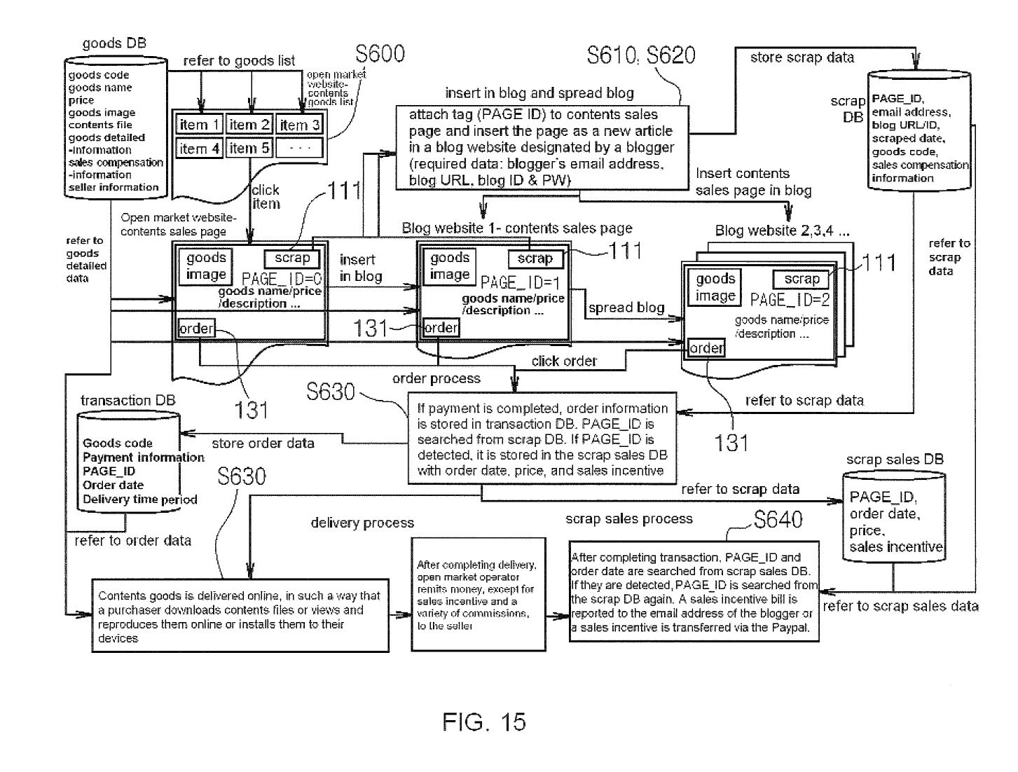

FIG. 14 is a schematic block diagram describing a method for selling goods through a blog share sales module in an open-market contents online delivery sales system (OC type) according to an embodiment of the present disclosure. FIG. 15 is a detailed block diagram describing a method for selling goods through a blog share sales module in an open-market contents online delivery sales system (OC type) according to an embodiment of the present disclosure.

Contents goods information, blog sales compensation information, and digital contents files to be sold, such as music, movies, moving images, images, comics, software, games, etc., are registered in the open market contents online delivery sales system (SC type) including a blog share sales module (S600).

Goods information, such as a list of items, prices, goods description, etc., is uploaded in an open market online delivery sales website that can support a blog share sales function, and then agency sales compensation information regarding blog share sales is input.

The goods information and agency sales compensation information refers to a contents sales page that is programmed to have an electronic commercial function in the open market online delivery sales website, and is exposed to users.

Next, the blog share sales module checks contents goods information and blog sales compensation information, registered in the open market contents online delivery sales system (OC type), inserts a sales page of corresponding content, as an article, in a blog, and stores an email address of a user who inserts the article in the blog, a date of blog article insertion, and a sales page inserted location in the share DB 120 for the OC type system (S610).

That is, the blogger checks the registered contents goods information and sales agency compensation information regarding blog share sales in the open market contents online delivery sales website.

After that, using user interfaces, such as buttons, to insert (share) an article in a blog, a contents sales page is inserted, as an article, in a blog that has a proper access right.

The share processing part associated with buttons receives personal recognition information such as an email address or a mobile phone number, which is used to identify a blogger, and then stores it in the BSS management server with a blog URL or information regarding a URL of an article where a contents sales page is contained.

After that, the contents sales page is copied as an article in an advertisement blog website by using a share button located at one side of the contents sales page inserted in the blog, and an email address of a blogger, blog shared date, and a blog sharing location are stored in the OC share DB 120 to spread the blog (S620).

That is, the URL of the contents sales page is transmitted to the blog article producing/editing part of the desired advertisement blog website through the blog article input linking part and registered as a blog article, so that the contents sales page is displayed through the blog article.

A third blogger checks the contents sales page inserted in the blog. The third blogger also checks registered contents goods information and sales agency compensation information regarding blog sales.

Using a user interface, such as a button, etc., prepared to insert (share) pages as an article in a blog, a contents sales page is inserted as an article in a blog that has a proper access right.

As such, contents sales pages disclosed in the Internet space can be spread to a variety of blog websites by a plurality of bloggers.

Since personal recognition information of a blogger who performs an insertion is stored in the OC share DB of a BBS module each time a contents sales page is inserted in a blog, the goods sales page can be tracked via the individuals who insets the pages in to various blogs. The personal recognition information can be used to identify a sales compensation beneficiary when a transaction has occurred in the contents sales page inserted in a blog.

After that, through a program associated with an order button located at one side of the contents sales page inserted as an article in the advertisement blog website, order information regarding a corresponding contents goods, a URL of the ordered contents item page, order date, price, and blog sales compensation information are stored in the OC share DB, and the corresponding contents are provided to the orderer by file download, online reference, online playback, or online installation (S630).

That is, when a contents purchaser purchases content using the order button that is programmed to have an electronic commercial function in a blog, the goods sales processing part of the open market system assigns a unique transaction number thereto and stores sales information, such as a sales date, a list of item, price, etc., and a blog URL (or a URL of an article containing contents sales page) in the transaction DB for the OC type system.

An ordered contents item in transaction DB for the OC type system, and corresponding content, searched from the goods DB of the open market system, are provided to the orderer by file download, online reference, online playback, or online installation.

The sales compensation processing part of the blog share sales module determines whether a purchase payment and a delivery completion, according to item purchase and blog sales, are performed. After that, bill information regarding sales compensation is transmitted to an email address of a blogger, blog sales compensation money is transferred to a blogger via the online payment system, or a guide message regarding sales compensation bill is transmitted to a blogger (S640).

That is, after contents provision has been completed, the cooperation sales linking part 11 controls the sales compensation processing part of the blog share sales module to process sales compensation to the blogger who inserted the contents sales page in a blog.

In an embodiment of the present disclosure, after transaction has been completed, the sales compensation processing part receives a unique number of a corresponding transaction, a contents sales page URL, and order date via the cooperation sales linking part 11 and searches the contents sales page URL from the share DB to seek an email address of a blogger who inserted the page in a blog. After that, the sales compensation processing part transmits a blog sales compensation money bill guide to the email or transfers blog sales compensation money thereto via the online payment system.

In an embodiment of the present disclosure, the blog sales compensation money is paid to a corresponding blogger with the online payment system. It should be, however, understood that the payment of the blog sales compensation money may be performed by cash transfer, cyber money, and predetermined goods or services.

In an embodiment of the present disclosure, the share sales DB stores bloggers' email addresses used for sales compensation, a state whether compensation money is paid, a payment date, a payment method, a URL of a sales page inserted as a blog article, a transaction unique number, etc.

The seller receives an amount that is calculated by subtracting share sales compensation money, and a variety of commissions and costs according to the use of open market system, from contents sales money.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

While the present disclosure is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art.

The disclosure in its broader aspects is therefore not limited to the specific details, representative apparatus and methods, and illustrative examples shown and described. Accordingly, departures may be made from such details without departing from the spirit or scope of applicants' general concept.

Therefore I claim:

1. A system for selling goods and contents through a blog share sales module, wherein:
a. the blog share sales module is included in an Internet shopping mall/open market system;
b. blogger recognition information is added to uniform resources locators (URLs) of goods sales page and auction page under control of the blog share sales module and then processed by iframe tags;
c. the goods sales and auction pages are inserted as an article in a blog, associating with the blog article producing/editing part of a advertisement blog system;
d. goods sales and auction are performed in the goods sales and auction pages which are then inserted as an article in the advertisement blog website; and
e. after a sale or an auction has been completed, sales compensation money is transferred to an email of the blogger who inserts the goods sales and auction pages as an article in the blog via the online payment system or a guide message regarding sales compensation bill is transmitted via email.

2. The system according to claim 1, wherein the blog share sales module comprises:
a. a share processing part that stores a URL of a corresponding goods sales/auction page, user's email address, a URL of a blog to which a goods sales/auction page is inserted, user's ID and password, when a user clicks a share button placed at one side of the goods sales/auction pages of the Internet shopping mall or open market, and calls a blog article input linking part to insert the goods sales/auction page as an article in the advertisement blog system via a blog article producing/editing part of the advertisement blog system;
b. a share DB that stores URLs of goods sales/auction pages, shared as the blog article by the share processing part, and information related to blog share, such as bloggers' email addresses, a URL of a blog to which the article is inserted, shared date, etc., based on share cases;
c. a sales compensation processing part that is called by the cooperating sales linking part of the Internet online shopping mall/open market system, when the goods sales or auction has been completed through the goods sales/auction page inserted in the advertisement blog website, and transmits information regarding sales completion and a bill of sales compensation to the blogger who inserts an article in a blog or transfers sales compensation money to a corresponding blogger via the online payment system;
d. a share sales DB that stores a URL of a goods sales/auction page of the purchased goods, the blogger's email address, order date, price, blog sales compensation money, a state whether sales compensation has been processed, etc., if a transaction has been completed in the goods sales/auction page that is inserted as the article in a blog; and
e. a blog article input linking part that links the blog share sales module to a blog article producing/editing part to insert the goods sales page and auction page as the blog article in the advertisement blog website, and inserts the pages as the article in the blog system via the blog article producing/editing part of the advertisement blog system.

3. The system according to claim 1, wherein the blog share sales module is selected from among an Internet shopping mall regular price sales system (SR type), an Internet shopping mall auction sales system (SA type), an open market regular-price sales system (OR type), an open market auction sales system (OA type), an Internet shopping mall contents online delivery sales system (SC type), and an open market contents online delivery sales system (OC).

4. The system according to claim 1, wherein the Internet shopping mall/open market system comprises:
a. a cooperating sales linking part that calls a sales compensation processing part of the blog share sales module and transmits transaction-related information thereto if goods sales and auction has been completed;
b. a goods sales/auction processing part that includes an order button at one side of the goods sales page and the auction page, stores order information regarding a corresponding goods in the transaction DB, simultaneously transmits order data to a delivery terminal in order to deliver a ordered goods to a delivery location, or delivers contents good to a purchaser by file download, online reference, and online reproduction (playback);
c. a transaction DB for storing order information regarding a corresponding item;
d. a goods information registering part that registers and stores URLs of goods sales page/auction page with respect to corresponding goods, goods prices, seller's email addresses, and telephone numbers in a goods DB; and
e. a goods sales/auction information displaying part that displays goods sales and auction information on the goods sales/auction page of the Internet shopping mall or open market.

5. A method for selling goods through a blog share sales module, comprising the steps of:
a. registering goods information and blog sales compensation information in an Internet shopping mall regular price sales system (SR type) including a blog share sales module;
b. checking, under the control of the blog share sales module, the goods information and blog sales compensation information, registered in the Internet shopping mall regular price system (SR type), inserting a sales page of a corresponding item, as an article, in a blog, and storing an email address of the user who inserts the article in the blog, a date of blog article insertion, and a sales page inserted location in a share DB for the SR type system;
c. spreading the blog that comprises copying the goods sales page as an article in a desired advertisement blog website by using a share button located at one side of the goods sales page inserted in the blog, and storing an email address of a blogger, a blog shared date, and a blog shared location in the SR share DB;
d. storing order information regarding a corresponding item, a URL of the ordered item page, order date, price, and blog sales compensation information in the SR share DB, through a program associated with an order button located at one side of the goods sales page inserted as an article in the advertisement blog website, and delivering the ordered item to a delivery location; and
e. determining, by the sales compensation processing part of the blog share sales module, whether a purchase payment and a delivery completion, according to item purchase and blog sales, are performed, and transmitting bill information regarding sales compensation to an email address of a blogger, transferring blog sales compensation money to a blogger via the online payment system, or transmitting a guide message regarding sales compensation bill to a blogger.

6. A method for selling goods through a blog share sales module, comprising the steps of:
a. registering goods information and blog sales compensation information in an Internet shopping mall auction sales system (SA type) including the blog share sales module;
b. checking, under the control of the blog share sales module, the goods information and blog sales compensation information, registered in the Internet shopping mall auction sales system (SA type), inserting an auction page of a corresponding item, as an article, in a blog, and storing an email address of a user who inserts the article in the blog, a date of blog article insertion, and an auction page inserted location in a share DB for the SA type system;
c. spreading the blog that comprises copying the goods auction page as an article in a desired advertisement blog website by using a share button located at one side of the goods auction page inserted in the blog, and storing an email address of the blogger, a blog shared date, and a blog shared location are stored in the SA share DB;
d. selecting, if a users bid by a bid button located at one side of the goods auction page inserted as an article in the advertisement blog website, a successful bidder, based on the highest price of the bidders, through a program associated with the bid button, storing successful bid information regarding a corresponding item, a URL of the auction page of the successful bid item, a successful bid date, price, and blog sales compensation information in the SA share DB, and delivering the successful bid item to a delivery location; and
e. determining, by a sales compensation processing part of the blog share sales module, whether a purchase payment and a delivery completion, according to item purchase and blog sales, are performed, and transmitting bill information regarding sales compensation to an email address of the blogger, transferring blog sales compensation money to the blogger via the online payment system, or transmitting a guide message regarding sales compensation bill to the blogger.

7. A method for selling goods through a blog share sales module, comprising the steps of:
a. registering goods information and blog sales compensation information in the open market regular price sales system (OR type) including the blog share sales module;
b. checking, under the control of the blog share sales module, goods information and blog sales compensation information, registered in an open market regular price sales system (OR type), inserting a sales page of a corresponding item, as an article, in a blog, and storing an email address of a user who inserts the article in the blog, a date of blog article insertion, and a sales page inserted location in a share DB for the OR type system;
c. spreading the blog that comprises copying the goods page, as an article, in a desired advertisement blog website by using a share button located at one side of the goods page inserted in the blog, and storing an email address of a blogger, a blog shared date, and a blog shared location are stored in the OR share DB;
d. storing ordered information regarding a corresponding item, a page URL of the ordered item, order date, price, and blog sales compensation information in the OR share DB, through a program associated with an order button located at one side of the goods page inserted as an article in the advertisement blog website, and transmitting the ordered data to a seller so that the ordered item can be delivered to a delivery location; and
e. determining, by a sales compensation processing part of the blog share sales module, whether a purchase payment and a delivery completion, according to item purchase and blog sales, are performed, and transmitting bill information regarding sales compensation to an email address of the blogger, transferring blog sales compensation money to the blogger via the online payment system, or transmitting a guide message regarding sales compensation bill to the blogger.

8. A method for selling goods through a blog share sales module, comprising the steps of:
a. registering goods information and blog sales compensation information in an open market auction sales system (OA type) including the blog share sales module;
b. checking, under the control of the blog share sales module, goods information and blog sales compensation information, registered in the open market auction sales system (OA type), inserting an auction page of a corresponding item, as an article, in a blog, and storing an email address of a user who inserts the article in the blog, a date of blog article insertion, and an auction page inserted location in a share DB for the OA type system, so that the blog is inserted;
c. spreading the blog that comprises copying the auction goods page as an article in a desired advertisement blog website by using a share button located at one side of the goods auction page inserted in the blog, and storing an email address of a blogger, a blog shared date, and a blog shared location in the OA share DB;
d. selecting, if users bid by a bid button located at one side of the goods auction page inserted as an article in the advertisement blog website, a successful bidder, based on the highest price of the bidders, through a program associated with the button, storing successful bid information regarding a corresponding item, a URL of the auction page of the successful bid item, a successful bid date, price, and blog sales compensation information in the OA share DB, and transmitting order data to a seller so that the successful bid item can be delivered to a delivery location; and
e. determining, by a sales compensation processing part of the blog share sales module, whether a purchase payment and a delivery completion, according to item purchase and blog sales, are performed, and transmitting bill information regarding sales compensation to an email address of a blogger, transferring blog sales compensation money to a blogger via the online payment system, or transmitting a guide message regarding sales compensation bill to a blogger.

9. A method for selling goods through a blog share sales module, comprising the steps of:
a. registering contents goods information, blog sales compensation information, and digital contents files to be sold, such as music, movies, moving images, images, comics, software, games, etc., in an Internet shopping mall contents online delivery sales system (SC type) including the blog share sales module;
b. checking, under the control of the blog share sales module, contents goods information and blog sales compensation information, registered in the Internet shopping mall contents online delivery sales system (SC type), inserting a sales page of a corresponding contents, as an article, in a blog, and storing an email address of a user who inserts the article in the blog, a date of blog article insertion, and a sales page inserted location in a share DB for the SC type system;
c. spreading the blog that comprises copying the contents sales page as an article in a desired advertisement blog website by using a share button located at one side of the contents sales page inserted in the blog, and storing an email address of a blogger, a blog shared date, and a blog shared location are stored in the SC share DB;
d. storing order information regarding a corresponding contents, a URL of the ordered contents item page, order date, price, and blog sales compensation information in the SC share DB, through a program associated with an order button located at one side of the contents sales page inserted as an article in the advertisement blog website, and providing the corresponding contents to an orderer by file download, online reference, online playback, or online installation; and
e. determining, by the sales compensation processing part of the blog share sales module, whether a purchase payment and a delivery completion, according to item purchase and blog sales, are performed, and transmitting bill information regarding sales compensation to an email address of a blogger, transferring blog sales compensation money to a blogger via the online payment system, or transmitting a guide message regarding sales compensation bill to a blogger.

10. A method for selling goods through a blog share sales module, comprising the steps of:
a. registering contents goods information, blog sales compensation information, and digital contents files to be sold, such as music, movies, moving images, images, comics, software, games, etc., in an open market contents online delivery sales system (SC type) including the blog share sales module;
b. checking, under the control of the blog share sales module, contents goods information and blog sales compensation information, registered in the open market contents online delivery sales system (OC type), inserting a sales page of a corresponding contents, as an article, in a blog, and storing an email address of a user who inserts the article in the blog, a date of blog article insertion, and a sales page inserted location in a share DB for the OC type system;
c. spreading the blog that comprises copying the contents sales page as an article in a desired advertisement blog website by using a share button located at one side of the contents sales page inserted in the blog, and storing an email address of a blogger, a blog shared date, and a blog shared location in the OC share DB;
d. storing order information regarding a corresponding contents goods, a URL of the ordered contents item page, order date, price, and blog sales compensation information in the OC share DB, through a program associated with an order button located at one side of the contents sales page inserted as an article in the advertisement blog website, and providing the corresponding contents to an orderer by file download, online reference, online playback, or online installation; and
e. determining, by a sales compensation processing part of the blog share sales module, whether a purchase payment and a delivery completion, according to item purchase and blog sales, are performed, and transmitting bill information regarding sales compensation to an email address of a blogger, transferring blog sales compensation money to a blogger via the online payment system, or transmitting a guide message regarding sales compensation bill to a blogger.

11. The method for selling goods through a blog share sales module, according to claim 5, where the step of spreading a blog further comprises the step of:
a. transmitting the URL of the goods sales page to the blog article producing/editing part of the advertisement blog website through the blog article input linking part, registering the page as an article in the blog, and displaying the goods sales page through the blog article.
